(19) United States
(12) Patent Application Publication
(10) Pub. No.: US 2025/0066925 A1
(43) Pub. Date: Feb. 27, 2025

(54) METHOD OF MANUFACTURING INTERIOR PARTS FOR A VEHICLE

(71) Applicants: HYUNDAI MOTOR COMPANY, Seoul (KR); KIA CORPORATION, Seoul (KR); BS TECHNICS CO.,LTD., Ansan-si (KR); ALPS ELECTRIC KOREA CO.,LTD., Gwangju (KR)

(72) Inventors: Young Ju Lee, Suwon-si (KR); Kwang Pyo Cho, Gwangmyeong-si (KR); Hong Sik Chang, Hwaseong-si (KR); Seung Sik Han, Hwaseong-si (KR); Young Jai Im, Hwaseong-si (KR); Jun Sik Kim, Gwacheon-si (KR); Young Do Kim, Ansan-si (KR); Jung Sik Choi, Siheung-si (KR); Tae Kyoung Jung, Bucheon-si (KR); In Ho Park, Incheon (KR); Seon Dong Kim, Gwangju (KR); Dae Woo Park, Gwangju (KR)

(73) Assignees: HYUNDAI MOTOR COMPANY, Seoul (KR); KIA CORPORATION, Seoul (KR); BS TECHNICS CO.,LTD., Ansan-si (KR); ALPS ELECTRIC KOREA CO.,LTD., Gwangju (KR)

(21) Appl. No.: 18/541,664

(22) Filed: Dec. 15, 2023

(30) Foreign Application Priority Data
Aug. 24, 2023 (KR) 10-2023-0110995

(51) Int. Cl. C23F 17/00; C23C 18/16; C25D 5/02; C25D 5/56

(52) U.S. Cl. CPC C23F 17/00; C23C 18/1689; C25D 5/022; C25D 5/56

(57) ABSTRACT

A method of manufacturing interior parts for a vehicle includes: forming a first plating layer on a surface of an injection molded product through electroless plating; printing a symbol part on the first plating layer; partially removing the first plating layer to a size corresponding to the symbol part from a rear surface of the injection molded product; forming a second plating layer on the first plating layer; and removing the symbol part and the first plating layer from the surface of the injection molded product on which the second plating layer is formed.

### CROSS-REFERENCE TO RELATED APPLICATION

This application claims, under 35 U.S.C. § 119 (a), the benefit of priority to Korean Patent Application No. 10-2023-0110995 filed on Aug. 24, 2023, the entire contents of which are incorporated herein by reference.

### BACKGROUND

### (a) Technical Field

The present disclosure relates to a method of manufacturing interior parts for a vehicle. More specifically, the present disclosure relates to a method of manufacturing interior parts for a vehicle, which can increase visibility and reduce production costs in manufacturing interior parts for a vehicle, such as switches, so that light is emitted to the outside through symbol parts in the form of letters or symbols.

### (b) Background Art

Generally, knobs are used in a variety of ways in vehicles or electronic products. For example, display type control knobs, such as change knobs on transmission gears, push type control knobs such as vehicle start buttons, and rotary control knobs such as audio volume control dials are used.

These control knobs are typically made of synthetic resin. However, recently, a light emission control knob, which provides an elegant and luxurious design and emits light provided from a light-emitting device to the outside through a light emission display window in the form of a letter or symbol to increase visibility, is getting attention.

The existing light emission control knob includes a light emission display window in the form of letters or symbols formed on an upper surface of a knob body made of synthetic resin. Additionally, the existing light emission control knob includes a light blocking layer formed on the remaining portions excluding, i.e., covering or blocking the light emission display window through painting or deposition.

However, when the existing light emission control knob is used for a long period of time, the light blocking layer becomes discolored or delaminated upon rubbing caused by direct contact with a user's finger.

In addition, the existing light emission control knob is made of a single color, leading to a problem of not satisfying various users' design preferences.

### SUMMARY

The present disclosure has been made in an effort to solve the above-described problems associated with the prior art.

In one aspect, the present disclosure provides a method of manufacturing interior parts for a vehicle that can implement a symbol part in the form of letters or symbols without disconnection to improve visibility. This is achieved by removing the symbol part in a state in which a first plating layer is formed on a surface of an injection molded product through electroless plating. The symbol part in the form of letters or symbols is printed on the injection molded product on which the first plating layer is formed. A second plating layer is formed on the other surface of the injection molded product excluding the symbol part through electroplating. As a result, the configuration allows light to be emitted to the outside of the interior parts through an area where the symbol part is removed.

Objectives of the present disclosure are not limited to the above-described objectives. The objectives of the present disclosure should become more apparent from the following description and should be implemented by the means described in the appended claims and a combination thereof.

In an embodiment, the present disclosure provides a method of manufacturing interior parts for a vehicle. The method includes forming a first plating layer on a surface of an injection molded product through electroless plating and printing a symbol part on the first plating layer. The method also includes partially removing the first plating layer to a size corresponding to the symbol part from a rear surface of the injection molded product and forming a second plating layer on the first plating layer. Additionally, the method includes removing the symbol part and the first plating layer from the surface of the injection molded product on which the second plating layer is formed.

When removing the symbol part, the symbol part and the first plating layer may be removed from the surface of the injection molded product through laser processing.

In addition, when removing the symbol part, the symbol part and the first plating layer may be sequentially removed from the surface of the injection molded product.

Removing the symbol part may include removing the symbol part from the surface of the injection molded product by chemical washing and may include removing the first plating layer by chemical washing.

When printing the symbol part, the symbol part may be printed on the first plating layer so that the first plating layer on which the symbol part is printed may be electrically disconnected.

In addition, when partially removing the first plating layer, the first plating layer may be partially removed through laser processing so that the rear surface of the injection molded product corresponding to the removed size may be electrically disconnected.

In addition, when partially removing the first plating layer, the injection molded product may be made of a light-transmitting material. Thus, the rear surface of the injection molded product may be exposed through the partial removal of the first plating layer so that a light emission display window facing the symbol part may be formed.

In addition, when forming the second plating layer, the second plating layer may be formed, by electroplating, on the first plating layer on the remaining surface of the injection molded product, excluding the symbol part and the rear surface of the injection molded product.

Other aspects of the present disclosure are discussed below.

It should be understood that the terms “vehicle” or “vehicular” or other similar terms as used herein are inclusive of motor vehicles in general. Such motor vehicles may encompass passenger automobiles including sports utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example vehicles that are both gasoline-powered and electric-powered.

The above and other features of the present disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a diagram sequentially illustrating a method of manufacturing interior parts for a vehicle according to an embodiment of the present disclosure;

FIG. 2 is a diagram illustrating printing of a symbol part in the method of manufacturing interior parts for a vehicle according to the embodiment of the present disclosure;

FIG. 3 is a diagram illustrating removal of a first plating layer in the method of manufacturing interior parts for a vehicle according to the embodiment of the present disclosure;

FIG. 4 is a diagram illustrating formation of a second plating layer in the method of manufacturing interior parts for a vehicle according to the embodiment of the present disclosure;

FIG. 5 is a diagram illustrating an example of the removal of the symbol part in the method of manufacturing interior parts for a vehicle according to the embodiment of the present disclosure;

FIGS. 6A and 6B are diagrams illustrating another example of the removal of the symbol part in the method of manufacturing interior parts for a vehicle according to the embodiment of the present disclosure;

FIG. 7 is a diagram illustrating a completed state of interior parts using the method of manufacturing interior parts for a vehicle according to the embodiment of the present disclosure; and

FIGS. 8A and 8B are diagrams illustrating configurations of conventional interior parts for a vehicle.

It should be understood that the appended drawings are not necessarily drawn to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, embodiments according to the present disclosure are described in detail with reference to the accompanying drawings.

The advantages and features of the present disclosure and the manner of achieving the advantages and features should become apparent with reference to the embodiments described in detail below with the accompanying drawings.

The present disclosure may, however, be implemented in many different forms and should not be construed as being limited to the embodiments set forth herein. Additionally, the embodiments are provided such that this disclosure is thorough and complete and should fully convey the scope of the present disclosure to those having ordinary skill in the art to which the present disclosure pertains. Furthermore, the present disclosure is defined by only the scope of the appended claims.

When a component, device, element, or the like of the present disclosure is described as having a purpose or performing an operation, function, or the like, the component, device, or element should be considered herein as being “configured to” meet that purpose or perform that operation or function.

Further, in the following description of the present disclosure, where a detailed description of a known related art has been determined to unnecessarily obscure the gist of the present disclosure, the detailed description thereof has been omitted herein.

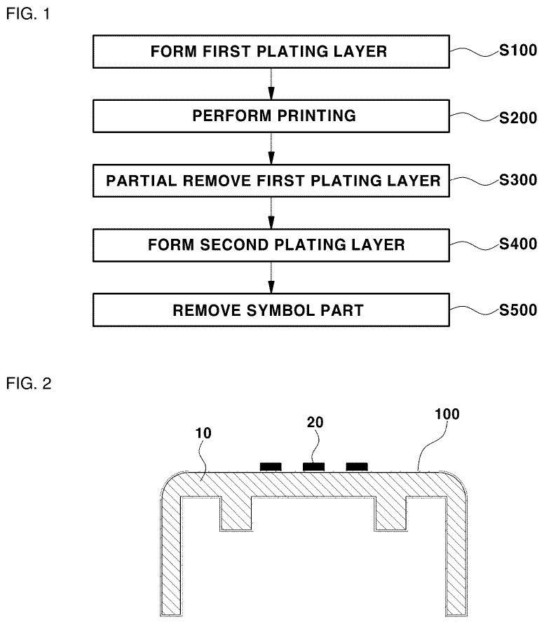

FIG. 1 is a diagram sequentially illustrating a method of manufacturing interior parts for a vehicle according to an embodiment of the present disclosure. FIG. 2 is a diagram illustrating the printing of a symbol part in the method of manufacturing interior parts for a vehicle according to the embodiment of the present disclosure.

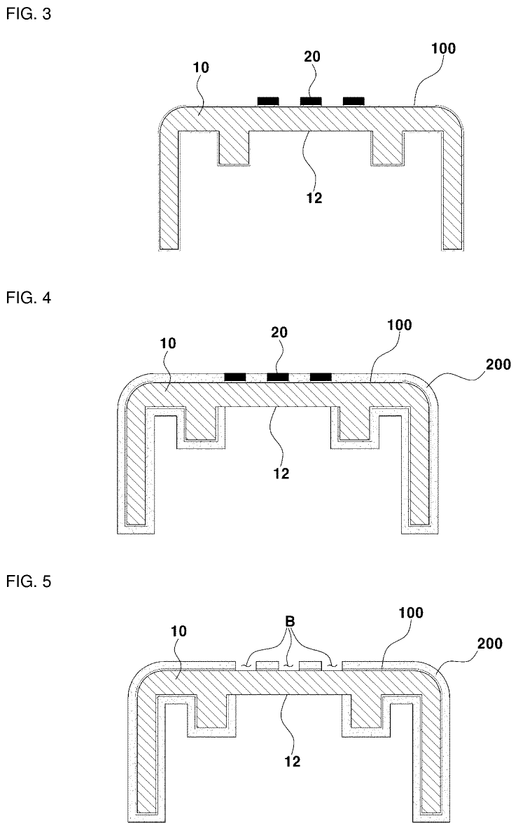

In addition, FIG. 3 is a diagram illustrating the removal of a first plating layer in the method of manufacturing interior parts for a vehicle according to the embodiment of the present disclosure. FIG. 4 is a diagram illustrating the formation of a second plating layer in the method of manufacturing interior parts for a vehicle according to the embodiment of the present disclosure.

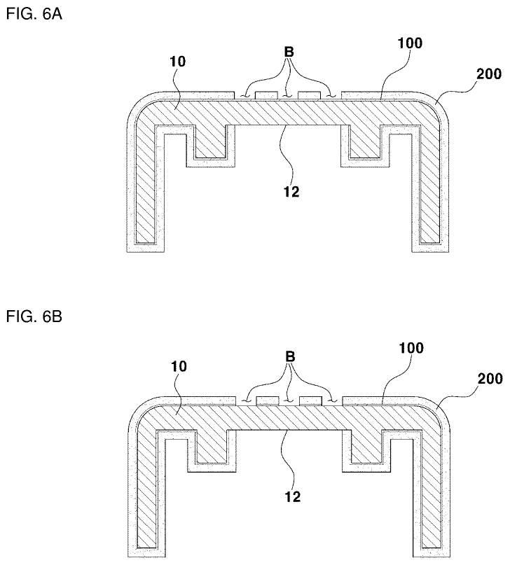

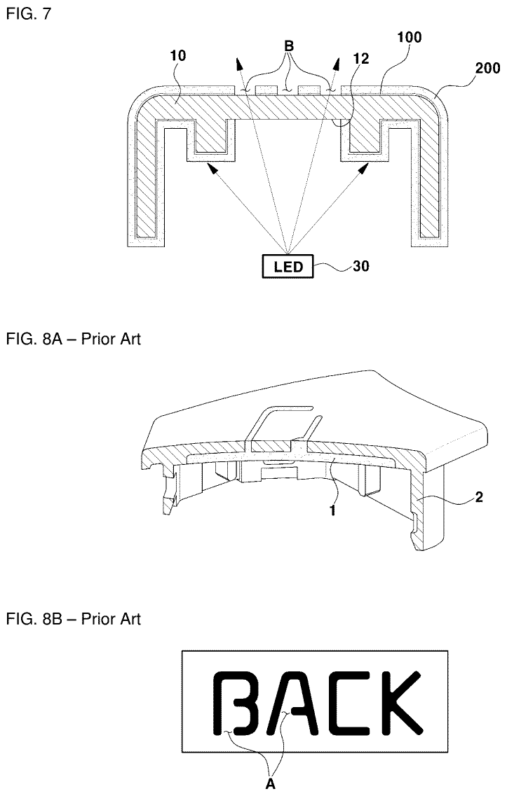

In addition, FIG. 5 is a diagram illustrating an example of the removal of the symbol part in the method of manufacturing interior parts for a vehicle according to the embodiment of the present disclosure. FIGS. 6A and 6B are diagrams illustrating another example of the removal of the symbol part in the method of manufacturing interior parts for a vehicle according to the embodiment of the present disclosure. FIG. 7 is a diagram illustrating a completed state of interior parts using the method of manufacturing interior parts for a vehicle according to the embodiment of the present disclosure.

Conventionally, in order to manufacture interior parts for a vehicle, such as switches, which emit light through symbol parts such as letters or images, it is inevitable to manufacture expensive molds for double injection of a first injection molded product and a second injection molded product.

In other words, as shown in FIG. 8A, according to the related art, a first mold is required for injection molding the first injection molded product 1 made of polycarbonate (PC) to form a light-transmitting symbol part. Also, a second mold is required for injection molding the second injection molded product 2 made of acrylonitrile butadiene styrene (ABS) to form plating areas on interior parts for a vehicle. As symbol parts with different shapes necessitate the re-manufacturing of the first mold for injection molding the first injection molded product 1, costs are bound to rise.

In addition, in performing plating in a plating area of the second injection molded product 2, assuming that the first injection molded product 1 is in a closed state, e.g., as shown in FIG. 8B, the first injection molded product 1 is formed with the letters “BACK.” This is done to perform plating on an interior of the first injection molded product 1. However, since it is necessary to implement islands A to expose the interiors of the letters “B” and “A,” visibility of the symbol part is inevitably reduced due to the implementation of the islands A.

In order to solve the above problem, as shown in FIG. 1, the method of manufacturing interior parts for a vehicle according to the present embodiment has been derived and is sequentially described as follows.

First, a first plating layer 100, which is a base plating layer using nickel (Ni), is formed on a surface of an injection molded product 10 made of PC and ABS through electroless plating (S100).

Then, as shown in FIG. 2, a symbol part 20 composed of letters or images with a predetermined thickness is printed on the first plating layer 100 using a pad printing method (S200).

As the symbol part 20 is printed on the first plating layer 100, the first plating layer 100 on which symbol part 20 is printed is masked so that a corresponding area is electrically disconnected.

Next, as shown in FIG. 3, the first plating layer 100 is partially removed to a size (e.g., area) corresponding to the symbol part 20 from a rear surface of the injection molded product 10 (S300).

This is because the injection molded product 10 is made of a light-transmitting material, including PC. The intention is to expose the rear surface of the injection molded product 10 to the outside, i.e., a light source 30, through partial removal of the first plating layer 100. In this way, a light emission display window 12 is formed on the rear side of the injection molded product 10.

In addition, since the first plating layer 100 is partially removed using fiber or ultraviolet (UV) laser processing, like the first plating layer 100 in the area where symbol part 20 is printed, the light emission display window 12 is also electrically disconnected.

Next, as shown in FIG. 4, a second plating layer 200, formed of triple plating copper (Cu)-nickel (Ni)-chromium (Cr), is formed on the first plating layer 100 (S400).

Preferably, the second plating layer 200 is formed by electroplating onto the first plating layer 100 having the symbol part 20 and the rear surface of the injection molded product 10. In other words, the second plating layer 200 is formed by electroplating onto the remaining surface of the injection molded product 10, excluding the light emission display window 12, through operation S400.

In one example, as described above, since the symbol part 20 and the light emission display window 12 are electrically disconnected, when the second plating layer 200 is formed through electroplating, the corresponding area is masked so that the second plating layer 200 is not formed.

The second plating layer 200 may be formed with a predetermined thickness, more specifically, a thickness corresponding to the printed thickness of the symbol part 20.

Thereafter, the symbol part 20 and the first plating layer 100 under the symbol part 20 are removed from the surface of the injection molded product 10 on which the second plating layer 200 is formed (S500).

As shown in FIG. 5, in operation S500, the symbol part 20 and the first plating layer 100 underneath the symbol part 20 may be removed from the surface of the injection molded product 10 in one process, i.e., using carbon dioxide (CO₂) or ultraviolet (UV) laser processing.

As another embodiment, as shown in FIGS. 6A and 6B, the symbol part 20 and the first plating layer 100 may be sequentially removed from the surface of the injection molded product 10.

In other words, as shown in FIG. 6A, the symbol part 20 is primarily removed from the surface of the injection molded product 10 by chemical washing. Additionally, in a state in which the symbol part 20 is removed, as shown in FIG. 6B, the first plating layer 100 is secondarily removed by chemical washing.

In one example, a polymer etchant is used to remove the symbol part 20, and a nitric acid-based nickel stripper is used to remove the first plating layer 100.

As described above, when the symbol part 20 and the first plating layer 100 are removed through laser processing or chemical washing, an interior part for a vehicle is completed as shown in FIG. 7. Furthermore, when light from the light source 30 passes through the injection molded product 10 through the light emission display window 12 to be emitted to a symbol area B where the symbol part 20 and the first plating layer 100 are removed, it is possible to provide a symbol part with improved visibility compared to the related art.

In addition, when different symbol parts 20 are printed on a plurality of injection molded products 10 according to different letters or shapes, it is possible to produce interior parts for a vehicle so that there is no need to manufacture molds for double injection as in the related art, and thus production costs can be reduced.

In addition, since the method is employed of implementing the symbol area B on the surface of the injection molded product 10 by removing the printed symbol part 20 in a state in which the second plating layer 200 is formed, the island A may be prevented from occurring (see FIG. 8B). As a result, recognition of a symbol shape can be improved when compared to the related art.

In accordance with the present disclosure, a method of manufacturing interior parts for a vehicle has an effect in that a symbol part in the form of letters or symbols can be implemented without disconnection to improve visibility. This is achieved by removing the symbol part in a state in which a first plating layer is formed on a surface of an injection molded product through electroless plating. The symbol part in the form of letters or symbols is printed on the injection molded product on which the first plating layer is formed. A second plating layer is formed on the surface of the injection molded product excluding the symbol part through electroplating. Light is thereby allowed to be emitted to the outside of the interior parts through an area where the symbol part is removed.

In addition, in accordance with the present disclosure, since the manufacture of an expensive mold for double injection of a polycarbonate (PC) material for forming a light-transmitting symbol part and an acrylonitrile butadiene styrene (ABS) material for forming a plating area is not required, reducing production cost may be achieved.

Although the present disclosure has been described with reference to the embodiment(s) shown in the drawings, this is merely illustrative. Various modifications may be made therefrom by those having ordinary skill in the art. Also, it should be understood that all or a part of the above-described embodiment(s) may be optionally combined and configured. Therefore, the true technical scope of the present disclosure should be defined by the technical spirit of the appended claims.

What is claimed is:

1. A method of manufacturing interior parts for a vehicle, the method comprising:
forming a first plating layer on a surface of an injection molded product through electroless plating;
printing a symbol part on the first plating layer;
partially removing the first plating layer to a size corresponding to the symbol part from a rear surface of the injection molded product;
forming a second plating layer on the first plating layer; and
removing the symbol part and the first plating layer from the surface of the injection molded product on which the second plating layer is formed.

2. The method of claim 1, wherein when removing the symbol part, the symbol part and the first plating layer are removed from the surface of the injection molded product through laser processing.

3. The method of claim 1, wherein when removing the symbol part, the symbol part and the first plating layer are sequentially removed from the surface of the injection molded product.

4. The method of claim 3, wherein removing the symbol part includes:
removing the symbol part from the surface of the injection molded product by chemical washing; and
removing the first plating layer by chemical washing.

5. The method of claim 1, wherein when printing the symbol part, the symbol part is printed on the first plating layer so that the first plating layer on which the symbol part is printed is electrically disconnected.

6. The method of claim 1, wherein when partially removing the first plating layer, the first plating layer is partially removed through laser processing so that the rear surface of the injection molded product corresponding to the removed size is electrically disconnected.

7. The method of claim 1, wherein when partially removing the first plating layer, the injection molded product is made of a light-transmitting material, and the rear surface of the injection molded product is exposed through the partial removal of the first plating layer so that a light emission display window facing the symbol part is formed.

8. The method of claim 1, wherein when forming the second plating layer, the second plating layer is formed, by electroplating, on the first plating layer on the remaining surface of the injection molded product, excluding the symbol part and the rear surface of the injection molded product.
